(19) United States
(12) Patent Application Publication
(10) Pub. No.: US 2023/0058984 A1
(43) Pub. Date: Feb. 23, 2023

(54) BATTERY COVER

(71) Applicant: NITTO DENKO CORPORATION, Osaka (JP)

(72) Inventors: Masakazu KATO, Osaka (JP); Kazumasa TAKAKURA, Osaka (JP); Makoto KAI, Osaka (JP); Takashi KOIZUMI, Osaka (JP); Hiromichi SAITO, Osaka (JP)

(73) Assignee: NITTO DENKO CORPORATION, Osaka (JP)

(21) Appl. No.: 17/784,501

(22) PCT Filed: Oct. 15, 2020
(86) PCT No.: PCT/JP2020/038950

§ 371 Date: Nov. 8, 2022

(30) Foreign Application Priority Data
Dec. 13, 2019 (JP) 2019-225671

(51) Int. Cl. H01M 10/658; H01M 50/155; H01M 50/15; H01M 10/647

(52) U.S. Cl. CPC H01M 10/658; H01M 50/155; H01M 50/15; H01M 10/647

(57) ABSTRACT

A battery cover 1 includes a side wall 2 covering a side surface S3 of a battery 100. The side wall 2 includes a first surface layer 11 in contact with the side surface S3 of the battery 100, a second surface layer 12 disposed on an opposite side of the side surface S3 of the battery 100 with respect to the first surface layer 11 in a thickness direction of the side wall 2, a heat insulating layer 13 disposed between the first surface layer 11 and the second surface layer 12 in the thickness direction, and a cushion layer 14 disposed between the first surface layer 11 and the heat insulating layer 13 in the thickness direction.

### TECHNICAL FIELD

The present invention relates to a battery cover.

### BACKGROUND ART

Conventionally, as a battery cover to be fitted to a battery, a battery cover provided with a side wall covering a side surface of the battery with the side wall including a porous layer having heat insulating properties and a protective layer disposed on one side and the other side in a thickness direction of the porous layer has been proposed (ref: for example, Patent Document 1).

### CITATION LIST

### Patent Document

Patent Document 1: International Publication WO2019/098231

### SUMMARY OF THE INVENTION

### Problem to be Solved by the Invention

In the battery cover described in Patent Document 1 described above, when there is a protruding portion on the side surface of the battery, the battery cover may be caught in the protruding portion, and the fitting of the battery cover to the battery may be hindered.

Accordingly, the present invention provides a battery cover which can be smoothly fitted to a battery.

### Means for Solving the Problem

The present invention [1] includes a battery cover including a side wall covering a side surface of a battery, wherein the side wall includes a first surface layer in contact with the side surface of the battery, a second surface layer disposed on an opposite side of the side surface of the battery with respect to the first surface layer in a thickness direction of the side wall, a heat insulating layer disposed between the first surface layer and the second surface layer in the thickness direction, and a cushion layer disposed between the first surface layer and the heat insulating layer in the thickness direction.

According to such a configuration, the side wall of the battery cover has the first surface layer in contact with the side surface of the battery, and the cushion layer disposed between the first surface layer and the heat insulating layer.

When the battery cover is fitted to the battery, the first surface layer of the side wall slides with respect to the side surface of the battery.

At this time, even when there is a protruding portion on the side surface of the battery, the cushion layer disposed at the inside (between the first surface layer and the heat insulating layer) of the side wall is deformed in accordance with the protruding portion, so that a catch of the first surface layer by the protruding portion can be suppressed.

Thus, even when there is a protruding portion on the side surface of the battery, the battery cover can smoothly ride over the protruding portion.

As a result, it is possible to smoothly fit the battery cover to the battery.

Also, in a state where the fitting of the battery cover to the battery is completed, the elasticity of the cushion layer allows the first surface layer to be reliably brought into contact with the side surface of the battery.

This allows a space between the side surface of the battery and the heat insulating layer to be filled with the cushion layer and the first surface layer.

As a result, it is possible to suppress an inflow of the air around the battery into the space between the side surface of the battery and the heat insulating layer, and it is possible to suppress conduction of the surrounding heat to the battery.

The present invention [2] includes the battery cover of the above-described [1], wherein the 50% compressive hardness of the cushion layer is lower than the 50% compressive hardness of the heat insulating layer.

According to such a configuration, it is possible to easily deform the cushion layer, while the shape of the heat insulating layer is retained.

The present invention [3] includes the battery cover of the above-described [2], wherein the 50% compressive hardness of the heat insulating layer is 10.0 kPa or more and the 50% compressive hardness of the cushion layer is 1.0 kPa or more and below 10.0 kPa.

According to such a configuration, it is possible to more easily deform the cushion layer, while the shape of the heat insulating layer is further retained.

The present invention [4] includes the battery cover of any one of the above-described [1] to [3], wherein the thermal conductivity of the heat insulating layer is 0.045 W/(m·K) or less.

According to such a configuration, it is possible to suppress the conduction of the surrounding heat to the battery by the heat insulating layer.

The present invention [5] includes the battery cover of any one of the above-described [1] to [4], wherein each of the heat insulating layer and the cushion layer is made of a foam-based heat insulating material or a fiber-based heat insulating material.

According to such a configuration, it is possible to easily fit the battery cover to the battery, and it is possible to improve heat insulating properties.

The present invention [6] includes the battery cover of any one of the above-described [1] to [5], wherein the battery has a first surface on which a terminal is disposed, a second surface away from the first surface in a first direction, and the side surface disposed between the first surface and the second surface in the first direction and extending in the first direction, and the cushion layer extends from one end portion over the other end portion of the side wall in the first direction.

According to such a configuration, in a state where the fitting of the battery cover to the battery is completed, it is possible to fill a space between the side surface of the battery and the heat insulating layer from one end portion over the other end portion of the side wall of the battery cover in the first direction.

The present invention [7] includes the battery cover of any one of the above-described [1] to [6], wherein the side wall has an inner surface in contact with the side surface of the battery in the thickness direction and an outer surface disposed on an opposite side of the side surface of the battery with respect to the inner surface in the thickness direction, and the outer surface has a recessed portion recessed in the thickness direction and a bulging portion bulging more than the recessed portion in the thickness direction.

According to such a configuration, it is possible to easily bend the side wall in the recessed portion, while the heat insulating properties are ensured in the bulging portion. Further, in the recessed portion, it is possible to avoid interference between a member disposed around the battery and the side wall.

The present invention [8] includes the battery cover of the above-described [7], wherein in a state where the battery cover is removed from the battery, a thickness of the heat insulating layer in the recessed portion is thinner than the thickness of the heat insulating layer in the bulging portion.

According to such a configuration, by molding the heat insulating layer, it is possible to form the recessed portion, while the thickness of the cushion layer is ensured.

The present invention [9] includes the battery cover of the above-described [7] or [8], wherein in a state where the battery cover is removed from the battery, the heat insulating layer in the recessed portion is compressed more than the heat insulating layer in the bulging portion in the thickness direction.

According to such a configuration, by compressing the heat insulating layer, it is possible to easily form the recessed portion.

The present invention [10] includes the battery cover of any one of the above-described [7] to [9], wherein the recessed portion extends along a corner of the battery.

According to such a configuration, it is possible to bend the side wall in accordance with the corner of the battery, and it is possible to fit the side wall to the side surface of the battery.

### Effect of the Invention

According to the battery cover of the present invention, it is possible to smoothly fit the battery cover to a battery.

### BRIEF DESCRIPTION OF THE DRAWINGS

FIG. 1 shows a perspective view of a battery to which a battery cover is fitted as one embodiment of the present invention.

FIG. 2 shows a perspective view of the battery shown in FIG. 1.

FIG. 3 shows a perspective view of the battery cover shown in FIG. 1.

FIG. 4 shows an A-A cross-sectional view of the battery cover shown in FIG. 3.

FIG. 5 shows a B-B cross-sectional view of the battery cover shown in FIG. 3.

FIGS. 6A and 6B show explanatory views for explaining a method for producing a battery cover;

FIG. 6A illustrating a laminating step and

FIG. 6B illustrating a molding step.

FIG. 7 shows a plan view of a laminate shown in FIG. 6B.

FIGS. 8A and 8B show explanatory views for explaining a method for fitting a battery cover to a battery;

FIG. 8A illustrating a state where the battery cover deforms a cushion material to be fitted to the battery and

FIG. 8B illustrating a state where the fitting of the battery cover to the battery is completed.

FIG. 9 shows an explanatory view for explaining a first modified example;

FIG. 9A illustrating a perspective view of a battery cover of the first modified example and

FIG. 9B illustrating a C-C cross-sectional view of the battery cover shown in FIG. 9A.

FIG. 10 shows an explanatory view for explaining a second modified example.

FIG. 11 shows an explanatory view for explaining a third modified example.

FIG. 12 shows a plan view of a test piece for evaluating heat insulating properties.

FIG. 13 shows a D-D cross-sectional view of the test piece shown in FIG. 12.

FIG. 14 shows a schematic configuration view of an evaluation device for evaluating heat insulating properties.

FIG. 15 shows a side view of a jig shown in FIG. 14 when viewed from an opposing direction.

FIG. 16 shows a plan view of a test piece for evaluating fitting properties.

FIG. 17 shows a schematic configuration view of an evaluation device for evaluating fitting properties.

FIG. 18 shows an explanatory view for explaining an evaluation method of fitting properties.

### DESCRIPTION OF EMBODIMENTS

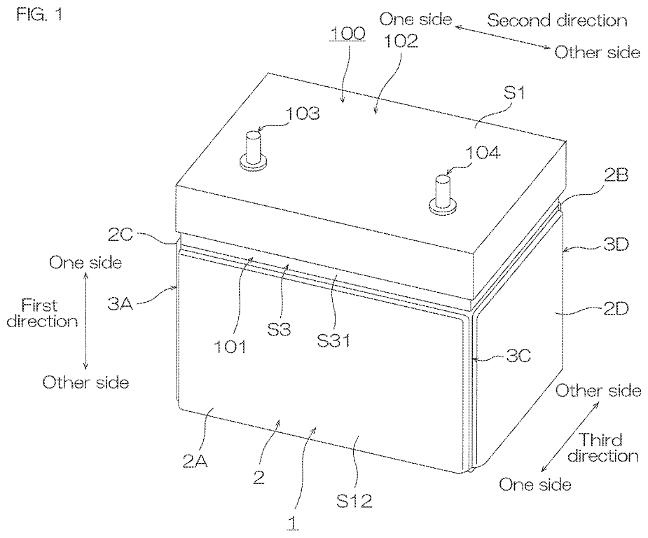

As shown in FIG. 1, a battery cover 1 as one embodiment of the present invention is fitted to a battery 100.

### 1. Battery 100

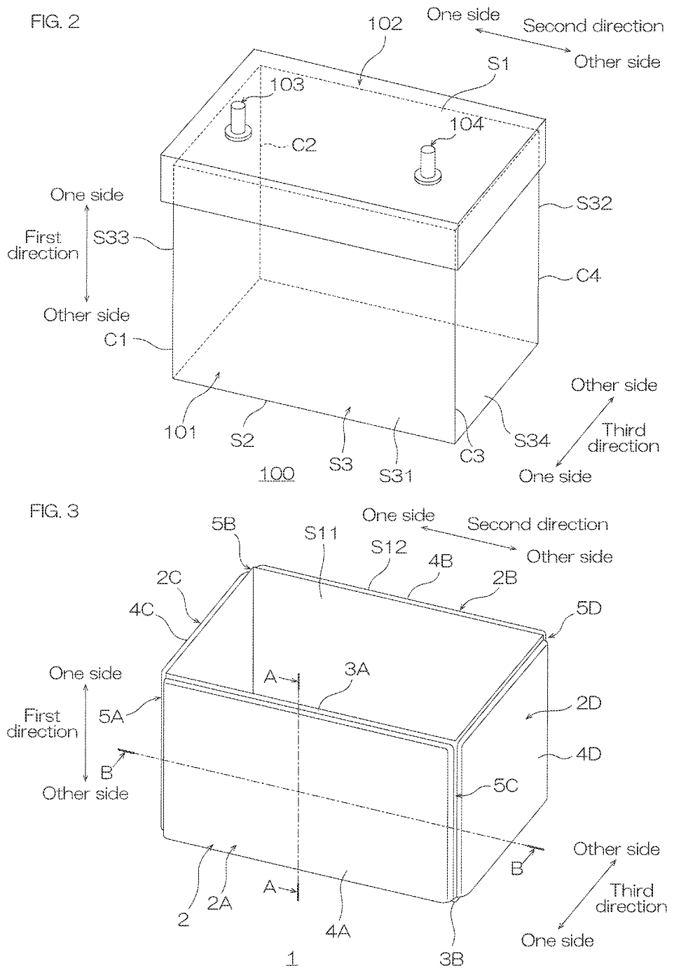

The battery 100 is described with reference to FIG. 2.

In the present embodiment, the battery 100 is a lead-acid battery. However, the battery 100 is not limited to the lead-acid battery, and it may be a secondary battery such as a lithium-ion secondary battery.

The battery 100 has a generally rectangular parallelepiped shape. The battery 100 includes a battery case 101, a lid 102, a positive electrode plate (not shown), a negative electrode plate (not shown), a positive electrode terminal 103 as one example of a terminal, and a negative electrode terminal 104 as one example of a terminal.

The battery case 101 has an opening (not shown). The opening is disposed in one end portion of the battery case 101 in a first direction. The battery case 101 houses the positive electrode plate, the negative electrode plate, and an electrolyte.

The lid 102 is attached to one end portion of the battery case 101 in the first direction. The lid 102 closes the opening in the battery case 101.

The positive electrode terminal 103 and the negative electrode terminal 104 are attached to the lid 102. The positive electrode terminal 103 is electrically connected to the positive electrode plate. The negative electrode terminal 104 is electrically connected to the negative electrode plate. The negative electrode terminal 104 is disposed to be spaced apart from the positive electrode terminal 103 in a second direction. The second direction is perpendicular to the first direction.

The battery 100 has a first surface S1, a second surface S2, and a side surface S3. In the present embodiment, the first surface S1 is an outer surface of the upper side of the lid 102. The positive electrode terminal 103 and the negative electrode terminal 104 are disposed on the first surface S1. The second surface S2 is an outer surface of the lower side of the battery case 101. That is, the second surface S2 is away from the first surface S1 in the first direction. The side surface S3 is a side surface of the battery case 101. The side surface S3 is disposed between the first surface S1 and the second surface S2 in the first direction. The side surface S3 extends in the first direction. In the present embodiment, the side surface S3 consists of a first side surface S31, a second side surface S32, a third side surface S33, and a fourth side surface S34.

The first side surface S31 is an outer surface of one side of the battery case 101 in a third direction. The third direction is perpendicular to the first direction and the second direction. The first side surface S31 extends in the first direction and the second direction.

The second side surface S32 is an outer surface of the other side of the battery case 101 in the third direction. The second side surface S32 extends in the first direction and the second direction.

The third side surface S33 is an outer surface of one side of the battery case 101 in the second direction. The third side surface S33 extends in the first direction and the third direction. One end portion of the third side surface S33 in the third direction is connected to one end portion of the first side surface S31 in the second direction. A portion where one end portion of the third side surface S33 in the third direction is connected to one end portion of the first side surface S31 in the second direction is a corner C1. The other end portion of the third side surface S33 in the third direction is connected to one end portion of the second side surface S32 in the second direction. A portion where the other end portion of the third side surface S33 in the third direction is connected to one end portion of the second side surface S32 in the second direction is a corner C2.

The fourth side surface S34 is an outer surface of the other side of the battery case 101 in the second direction. The fourth side surface S34 extends in the first direction and the third direction. One end portion of the fourth side surface S34 in the third direction is connected to the other end portion of the first side surface S31 in the second direction. A portion where one end portion of the fourth side surface S34 in the third direction is connected to the other end portion of the first side surface S31 in the second direction is a corner C3. The other end portion of the fourth side surface S34 in the third direction is connected to the other end portion of the second side surface S32 in the second direction. A portion where the other end portion of the fourth side surface S34 in the third direction is connected to the other end portion of the second side surface S32 in the second direction is a corner C4.

### 2. Battery Cover 1

Next, the battery cover 1 is described with reference to FIGS. 1 to 5.

As shown in FIG. 1, in a state where the battery cover 1 is fitted to the battery 100, the battery cover 1 covers the outer surface of the battery 100. In a state where the battery cover 1 is fitted to the battery 100, the battery cover 1 suppresses conduction of the surrounding heat to the battery 100.

The battery cover 1 may expose a portion of the outer surface of the battery 100. In the present embodiment, in a state where the battery cover 1 is fitted to the battery 100, the battery cover 1 covers the side surface S3 of the battery 100, and exposes the first surface S1 and the second surface S2 (ref: FIG. 2) of the battery 100. In a state where the battery cover 1 is fitted to the battery 100, the battery cover 1 surrounds the battery 100.

(1) Shape of Battery Cover 1

As shown in FIG. 3, the battery cover 1 has a tubular shape. The battery cover 1 extends in the first direction. The battery cover 1 includes a side wall 2. In the present embodiment, the battery cover 1 consists of only the side wall 2. In a state where the battery cover 1 is fitted to the battery 100 (ref: FIG. 1), the side wall 2 covers the side surface S3 of the battery 100. In the present embodiment, the side wall 2 consists of a first side wall 2A, a second side wall 2B, a third side wall 2C, and a fourth side wall 2D.

The first side wall 2A is disposed in one end portion of the battery cover 1 in the third direction. The first side wall 2A extends in the first direction and the second direction. The first side wall 2A has a flat plate shape. In a state where the battery cover 1 is fitted to the battery 100, the first side wall 2A covers the first side surface S31 (ref: FIG. 2) of the battery 100.

The second side wall 2B is disposed in the other end portion of the battery cover 1 in the third direction. The second side wall 2B is disposed to be spaced apart from the first side wall 2A in the third direction. In a state where the battery cover 1 is fitted to the battery 100, the second side wall 2B is disposed on an opposite side of the first side wall 2A with respect to the battery 100 in the third direction. The second side wall 2B extends in the first direction and the second direction. The second side wall 2B has a flat plate shape. In a state where the battery cover 1 is fitted to the battery 100, the second side wall 2B covers the second side surface S32 (ref: FIG. 2) of the battery 100.

The third side wall 2C is disposed in one end portion of the battery cover 1 in the second direction. The third side wall 2C extends in the first direction and the third direction. The third side wall 2C has a flat plate shape. In a state where the battery cover 1 is fitted to the battery 100, the third side wall 2C covers the third side surface S33 (ref: FIG. 2) of the battery 100. One end portion of the third side wall 2C in the third direction is connected to one end portion of the first side wall 2A in the second direction. The other end portion of the third side wall 2C in the third direction is connected to one end portion of the second side wall 2B in the second direction.

The fourth side wall 2D is disposed in the other end portion of the battery cover 1 in the second direction. The fourth side wall 2D is disposed to be spaced apart from the third side wall 2C in the second direction. In a state where the battery cover 1 is fitted to the battery 100, the fourth side wall 2D is disposed on an opposite side of the third side wall 2C with respect to the battery 100 in the second direction. The fourth side wall 2D extends in the first direction and the third direction. The fourth side wall 2D has a flat plate shape. In a state where the battery cover 1 is fitted to the battery 100, the fourth side wall 2D covers the fourth side surface S34 (ref: FIG. 2) of the battery 100. One end portion of the fourth side wall 2D in the third direction is connected to the other end portion of the first side wall 2A in the second direction. The other end portion of the fourth side wall 2D in the third direction is connected to the other end portion of the second side wall 2B in the second direction.

Further, the side wall 2 has an inner surface S11 and an outer surface S12.

In a state where the battery cover 1 is fitted to the battery 100, the inner surface S11 is in contact with the side surface S3 (ref: FIG. 2) of the battery 100 in a thickness direction of the side wall 2. In the present embodiment, in the first side wall 2A and the second side wall 2B, the “thickness direction” refers to the third direction. Further, in the third side wall 2C and the fourth side wall 2D, the “thickness direction” refers to the second direction.

In a state where the battery cover 1 is fitted to the battery 100, the outer surface S12 is disposed on an opposite side of the side surface S3 (ref: FIG. 2) of the battery 100 with respect to the inner surface S11 in the thickness direction.

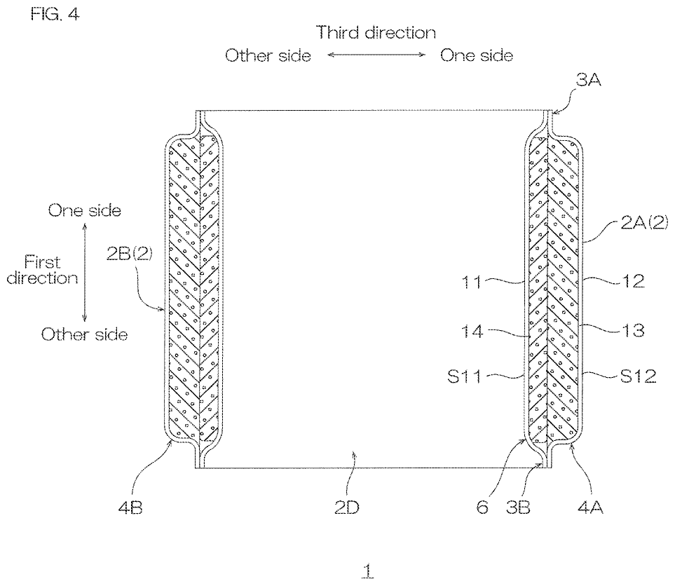

Furthermore, the side wall 2 has edge portions 3A and 3B, outer-side bulging portions 4A to 4D as a plurality of bulging portions, a plurality of recessed portions 5A to 5D, and an inner-side bulging portion 6 (ref: FIG. 4).

(1-1) Edge Portions 3A and 3B

As shown in FIGS. 3 and 4, the edge portion 3A is disposed in one end portion (upper end portion) of the battery cover 1 in the first direction. The edge portion 3A extends the full perimeter of the battery cover 1. In the present embodiment, the edge portion 3A extends in the second direction in the first side wall 2A and the second side wall 2B, and extends in the third direction in the third side wall 2C and the fourth side wall 2D.

The edge portion 3B is disposed to be spaced apart from the edge portion 3A in the first direction. The edge portion 3B is disposed in the other end portion (lower end portion) of the battery cover 1 in the first direction. The edge portion 3B extends the full perimeter of the battery cover 1 as well as the edge portion 3A.

(1-2) Outer-Side Bulging Portions 4A to 4D

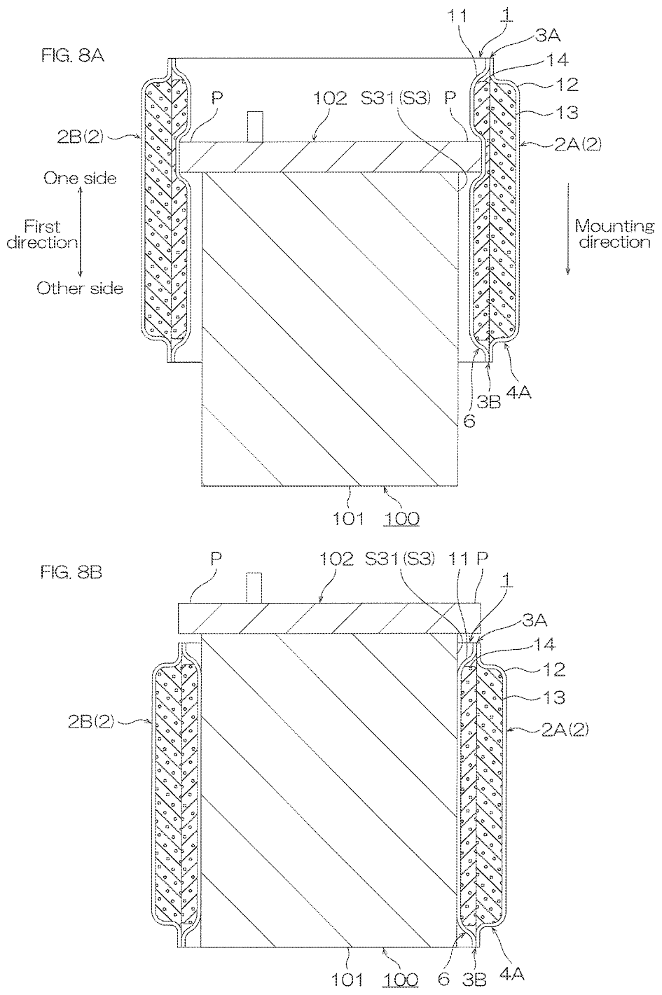

As shown in FIGS. 3 and 4, the plurality of outer-side bulging portions 4A to 4D are disposed between the edge portion 3A and the edge portion 3B in the first direction. Each of the plurality of outer-side bulging portions 4A to 4D bulges more outwardly than the edge portion 3A and the edge portion 3B in the thickness direction. In a state where the battery cover 1 is fitted to the battery 100 (ref: FIG. 8B), each of the plurality of outer-side bulging portions 4A to 4D bulges toward the opposite side of the side surface S3 (ref: FIG. 1) of the battery 100 with respect to the edge portion 3A and the edge portion 3B in the thickness direction.

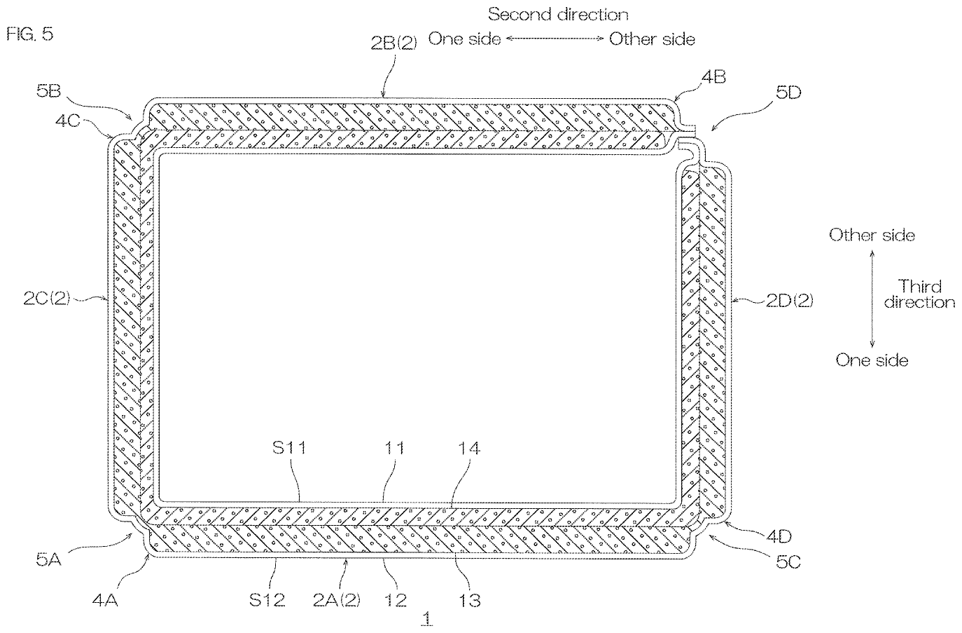

As shown in FIGS. 3 and 5, the outer-side bulging portion 4A is disposed on the outer surface S12 of the first side wall 2A. The outer-side bulging portion 4B is disposed on the outer surface S12 of the second side wall 2B. The outer-side bulging portion 4C is disposed on the outer surface S12 of the third side wall 2C. The outer-side bulging portion 4D is disposed on the outer surface S12 of the fourth side wall 2D.

(1-3) Recessed Portions 5A to 5D

As shown in FIG. 3, the plurality of recessed portions 5A to 5D are disposed between the edge portion 3A and the edge portion 3B in the first direction. The recessed portion 5A is disposed in the connecting portion between the first side wall 2A and the third side wall 2C. The recessed portion 5B is disposed in the connecting portion between the second side wall 2B and the third side wall 2C. The recessed portion 5C is disposed in the connecting portion between the first side wall 2A and the fourth side wall 2D. The recessed portion 5D is disposed in the connecting portion between the second side wall 2B and the fourth side wall 2D. Each of the plurality of recessed portions 5A to 5D extends in the first direction. In a state where the battery cover 1 is fitted to the battery 100, the recessed portion 5A extends along the corner C1 (ref: FIG. 2), the recessed portion 5B extends along the corner C2 (ref: FIG. 2), the recessed portion 5C extends along the corner C3 (ref: FIG. 2), and the recessed portion 5D extends along the corner C4 (ref: FIG. 2).

As shown in FIG. 5, each of the plurality of recessed portions 5A to 5D is recessed from the outer surface S12 toward the inner surface S11 in the thickness direction. Specifically, each of the plurality of recessed portions 5A to 5D is recessed more than the plurality of outer-side bulging portions 4A to 4D in the thickness direction. In other words, each of the plurality of outer-side bulging portions 4A to 4D bulges more than the plurality of recessed portions 5A to 5D. The plurality of recessed portions 5A to 5D are formed on the outer surface S12. That is, the outer surface S12 has the plurality of recessed portions 5A to 5D.

(1-4) Inner-Side Bulging Portion 6

As shown in FIG. 4, the inner-side bulging portion 6 is disposed on the inner surface S11 of the side wall 2. The inner-side bulging portion 6 is disposed between the edge portion 3A and the edge portion 3B in the first direction. The inner-side bulging portion 6 bulges more inwardly than the edge portion 3A and the edge portion 3B in the thickness direction. In a state where the battery cover 1 is fitted to the battery 100 (ref: FIG. 8B), the inner-side bulging portion 6 bulges from the edge portion 3A and the edge portion 3B toward the side surface S3 of the battery 100 in the thickness direction.

As shown in FIG. 5, the inner-side bulging portion 6 is disposed from the first side wall 2A over the fourth side wall 2D.

(2) Layer Structure of Battery Cover 1

As shown in FIGS. 4 and 5, the battery cover 1 includes a first surface layer 11, a second surface layer 12, a heat insulating layer 13, and a cushion layer 14. In other words, the side wall 2 includes the first surface layer 11, the second surface layer 12, the heat insulating layer 13, and the cushion layer 14.

(2-1) First Surface Layer 11

The first surface layer 11 is the innermost layer of the side wall 2 in the thickness direction. In a state where the battery cover 1 is fitted to the battery 100 (ref: FIG. 8B), the first surface layer 11 is disposed between the side surface S3 of the battery 100 and the cushion layer 14, or between the side surface S3 of the battery 100 and the heat insulating layer 13 in the thickness direction. The first surface layer 11 protects the heat insulating layer 13 and the cushion layer 14 at the inside in the thickness direction. The first surface layer 11 is disposed on the entire side wall 2. In a state where the battery cover 1 is fitted to the battery 100, the first surface layer 11 is in contact with the side surface S3 of the battery 100. The first surface layer 11 has the inner surface S11.

Examples of a material for the first surface layer 11 include a nonwoven fabric, a woven fabric, a plastic sheet, and a plastic film.

Examples of a material for the nonwoven fabric and the woven fabric include natural fibers such as cotton, hemp, pulp, wool, silk, and mineral fibers, and chemical fibers such as polyester fibers, polyethylene fibers, polypropylene fibers, nylon fibers, aramid fibers, acrylic fibers, vinylon fibers, rayon, and glass fibers. The nonwoven fabric and the woven fabric may be made of a single kind of fiber or may be made of a plurality of kinds of fibers.

Examples of a material for the plastic sheet and the plastic film include thermosetting resins such as polyester resins, polyurethane resins, and polycarbonate resins, and thermoplastic resins such as polyolefin resins, polyvinyl chloride, and styrene butadiene rubber. The plastic sheet and the plastic film may be made of a single kind of resin or may be made of a plurality of kinds of resins.

The first surface layer 11 is preferably made of a nonwoven fabric. When the first surface layer 11 is made of a nonwoven fabric, as a material for the nonwoven fabric, preferably, a chemical fiber is used, more preferably, a polyester fiber and a polypropylene fiber are used, further more preferably, a polyethylene terephthalate (PET) fiber and a polypropylene fiber are used.

When the first surface layer 11 includes the polyethylene terephthalate fiber, it is possible to improve heat resistance of the first surface layer 11. When the first surface layer 11 includes the polypropylene fiber, it is possible to easily thermally weld the first surface layer 11 to the second surface layer 12. When the first surface layer 11 includes the polyethylene terephthalate fiber and the polypropylene fiber, it is possible to achieve both the heat resistance of the first surface layer 11 and the heat weldability of the first surface layer 11 with respect to the heat insulating layer 13 or the second surface layer 12.

A method for producing the nonwoven fabric is not limited. Examples of the method for producing the nonwoven fabric include fleece forming methods such as a dry method, a wet method, a spunbond method, and a melt blow method, and fleece bonding methods such as a thermal bonding method, a chemical bonding method, a stitch bonding method, a needle punch method, a span race method, and a steam jet method.

The nonwoven fabric may be impregnated with a resin. The resin to be impregnated into the nonwoven fabric is not limited. Examples of the resin to be impregnated into the nonwoven fabric include thermosetting resins such as a phenol resin and a resorcinol resin, and thermoplastic resins such as vinyl acetate-based resins including ethylene vinyl acetate (EVA) and olefinic resins including amorphous polyolefin (APAO).

Further, the nonwoven fabric may be a laminate of a resin layer and a fiber layer. An example of the resin layer includes a layer made of the above-described vinyl acetate-based resin. An example of the fiber layer includes a layer made of the above-described material for the nonwoven fabric and the woven fabric. Specifically, an example thereof includes a nonwoven fabric in which a vinyl acetate-based resin, a polyester fiber (more specifically, a polyethylene terephthalate fiber), and a polypropylene fiber are laminated in the order of the vinyl acetate-based resin (resin layer), the polyester fiber (fiber layer), the polypropylene fiber (fiber layer), and the vinyl acetate-based resin (resin layer).

A thickness of the first surface layer 11 is thinner than that of the heat insulating layer 13 and the cushion layer 14. The thickness of the first surface layer 11 is, for example, 0.01 mm or more, preferably 0.1 mm or more, and for example, 10.0 mm or less, preferably 5.0 mm or less.

(2-2) Second Surface Layer 12

The second surface layer 12 is the outermost layer of the side wall 2 in the thickness direction. The second surface layer 12 is disposed on an opposite side of the first surface layer 11 with respect to the heat insulating layer 13 and the cushion layer 14 in the thickness direction. The second surface layer 12 protects the heat insulating layer 13 and the cushion layer 14 at the outside in the thickness direction. In a state where the battery cover 1 is fitted to the battery 100 (ref: FIG. 8B), the second surface layer 12 is disposed on an opposite side of the side surface S3 of the battery 100 with respect to the first surface layer 11 in the thickness direction. The second surface layer 12 is disposed on the entire side wall 2. The second surface layer 12 has the outer surface S12. In the edge portion 3A and the edge portion 3B, the second surface layer 12 is bonded to the first surface layer 11.

An example of a material for the second surface layer 12 includes the same material as that for the first surface layer 11. The second surface layer 12 may be made of the same material as that for the first surface layer 11, or may be made of a material different from that for the first surface layer 11.

A thickness of the second surface layer 12 is thinner than that of the heat insulating layer 13 and the cushion layer 14. The thickness of the second surface layer 12 is, for example, 0.01 mm or more, preferably 0.1 mm or more, and for example, 10.0 mm or less, preferably 5.0 mm or less. The thickness of the second surface layer 12 may be the same as that of the first surface layer 11, or may be different from that of the first surface layer 11.

(2-3) Heat Insulating Layer 13

The heat insulating layer 13 is disposed between the first surface layer 11 and the second surface layer 12 in the thickness direction. The heat insulating layer 13 is disposed between the cushion layer 14 and the second surface layer 12 in the thickness direction. The heat insulating layer 13 is disposed in each of the outer-side bulging portions 4A to 4D. In the present embodiment, the heat insulating layer 13 is disposed in each of the outer-side bulging portions 4A to 4D and each of the recessed portions 5A to 5C. The heat insulating layer 13 is bonded to the second surface layer 12. The heat insulating layer 13 is made of a heat insulating material.

Examples of the heat insulating material include foam-based heat insulating materials such as urethane foam, phenol foam, polyethylene foam, and polystyrene foam, and fiber-based heat insulating materials such as glass wool, rock wool, nonwoven fabrics containing silica aerogel, and cellulose fibers.

The heat insulating layer 13 is preferably made of a foam-based heat insulating material, more preferably made of urethane foam.

The thermal conductivity of the heat insulating layer 13 is 0.045 W/(m·K) or less, preferably 0.043 W/(m·K) or less, more preferably 0.040 W/(m·K) or less, further more preferably 0.035 W/(m·K) or less, further more preferably 0.033 W/(m·K) or less, further more preferably 0.030 W/(m·K) or less, and for example, 0.015 W/(m·K) or more. The thermal conductivity is measured by a hot wire method (probe method) in conformity with JIS R 2616: 2001 or ASTM D 5930. Specifically, the thermal conductivity is measured at room temperature using a rapid thermal conductivity meter (manufactured by KYOTO ELECTRONICS MANUFACTURING CO., LTD., trade name “QTM-500”). The thermal conductivity of the heat insulating layer 13 is the main factor affecting the heat insulating properties of the battery cover 1. The heat insulating properties of the battery cover 1 can be evaluated by the method described in Examples to be described later.

Examples of the other factor affecting the heat insulating properties of the battery cover 1 include the thermal conductivity of the cushion layer 14, the air permeability of the heat insulating layer 13, and the air permeability of the cushion layer 14 to be described later. When the air permeability of the heat insulating layer 13 is excessively high, it becomes difficult to block the high-temperature air flow by the battery cover 1, so that there is a tendency that the heat insulating properties of the battery cover 1 are reduced.

The air permeability of the heat insulating layer 13 is preferably lower than that of the cushion layer 14. More preferably, the air permeability of the heat insulating layer 13 is lower than that of the first surface layer 11, the second surface layer 12, and the cushion layer 14. The air permeability can be measured by the B method defined by JIS K 6400-7: 2012 in the case of a foam, and by the Frazier forming method defined by JIS L 1913: 2010 in the case of a nonwoven fabric.

The air permeability of the heat insulating layer 13 is, for example, 160 ml/cm²/sec or less, preferably 100 ml/cm²/sec or less, more preferably 75 ml/cm²/sec or less. When the air permeability of the heat insulating layer 13 is the above-described upper limit value or less, it is possible to suppress a reduction in the heat insulating properties of the battery cover 1.

The heat insulating layer 13 is harder than the cushion layer 14. The 50% compressive hardness of the heat insulating layer 13 is higher than that of the cushion layer 14. The 50% compressive hardness is measured in conformity with JIS K 6767: 1999. Specifically, a dimension (width×length) of a test piece to be subjected to measurement of the 50% compressive hardness is 100 mm×100 mm. The 50% compressive hardness is calculated by the following formula based on the load P measured immediately after stopping the compression obtained by placing the test piece between parallel flat plates of a testing machine and compressing only 50% of the initial thickness at a compression rate of 5 mm/min to be stopped.

50% compressive hardness=load P÷area of test piece (100 mm×100 mm) Formula:

The 50% compressive hardness of the heat insulating layer 13 is, for example, 10.0 kPa or more, preferably 11.0 kPa or more, more preferably 12.0 kPa or more. When the 50% compressive hardness of the heat insulating layer 13 is the above-described lower limit value or more, it is possible to suppress deformation of the heat insulating layer 13 after a molding step to be described later. The upper limit value of the 50% compressive hardness of the heat insulating layer 13 is not limited as long as it can compress the heat insulating layer 13 in the molding step to be described later.

A compressive hardness retention rate after 120 seconds of the heat insulating layer 13 is, for example, below 75%, preferably 70% or less, and for example, 10% or more.

The compressive hardness retention rate after 120 seconds is measured by the method described in Examples to be described later.

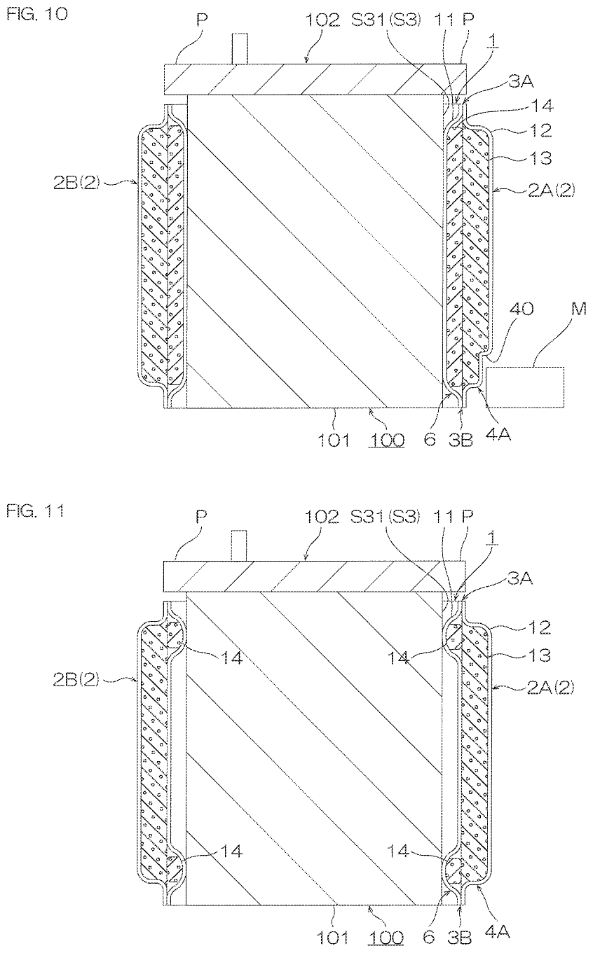

When the compressive hardness retention rate after 120 seconds of the heat insulating layer 13 is the above-described upper limit value or less (i.e., the compressive hardness is likely to decrease in a compressed state and less likely to be easily restored from the compressed state), it is possible to suppress the deformation of the heat insulating layer 13 after the molding step to be described later. Thus, it is possible to retain the shapes of the recessed portions 5A to 5C, and a recessed portion 40 (ref: FIG. 10) of a modified example to be described later Thus, it is possible to bend the side wall 2 in the recessed portions 5A to 5C so that each recessed portion 5A to 5D is fitted to each corner C1 to C4 of the battery 100. As a result, it is possible to easily fit the battery cover 1 to the battery 100. Further, it is possible to suppress interference between a member M (ref: FIG. 10) disposed around the battery 100 and the side wall 2 by the recessed portion 40.

In a state where the battery cover 1 is removed from the battery 100, a thickness of the heat insulating layer 13 in each outer-side bulging portion 4A to 4D is, for example, 3 mm or more, preferably 5 mm or more, and for example, 25 mm or less, preferably 20 mm or less. When the thickness of the heat insulating layer 13 in each outer-side bulging portion 4A to 4D is the above-described lower limit value or more, it is possible to ensure the heat insulating properties of the battery cover 1. When the thickness of the heat insulating layer 13 in each outer-side bulging portion 4A to 4D is the above-described upper limit value or less, it is possible to suppress excessive enlargement of the battery cover 1.

In a state where the battery cover 1 is removed from the battery 100, a thickness of the heat insulating layer 13 in each recessed portion 5A to 5C is thinner than that of the heat insulating layer 13 in each outer-side bulging portion 4A to 4D. Specifically, the thickness of the heat insulating layer 13 in each recessed portion 5A to 5C is, for example, 10 mm or less, preferably 5 mm or less, and for example, 1 mm or more. When the thickness of the heat insulating layer 13 in each recessed portion 5A to 5C is thinner than that of the heat insulating layer 13 in each outer-side bulging portion 4A to 4D, it is possible to easily bend the side wall 2 in each recessed portion 5A to 5C. When the side wall 2 is bent in each recessed portion 5A to 5C, it is possible to fit the side wall 2 to the side surface S3 of the battery 100.

In a state where the battery cover 1 is removed from the battery 100, the density of the heat insulating layer 13 in each outer-side bulging portion 4A to 4D is, for example, 100 kg/m³ or less, preferably 50 kg/m³ or less, and for example, 1 kg/m³ or more, preferably 10 kg/m³ or more. The density is measured in conformity with JIS A 9521: 2017 or JIS K 6767: 1999. When the density is the above-described upper limit value or less, it is possible to reduce the thermal conductivity.

In a state where the battery cover 1 is removed from the battery 100, the heat insulating layer 13 in each recessed portion 5A to 5C is compressed more than the heat insulating layer 13 in each outer-side bulging portion 4A to 4D in the thickness direction. In other words, the density of the heat insulating layer 13 in each recessed portion 5A to 5C is higher than that of the heat insulating layer 13 in each outer-side bulging portion 4A to 4D. The density of the heat insulating layer 13 in each recessed portion 5A to 5C is, for example, 10 kg/m³ or more, and 70 kg/m³ or less.

(2-4) Cushion Layer 14

The cushion layer 14 is disposed between the first surface layer 11 and the heat insulating layer 13 in the thickness direction. The cushion layer 14 is disposed at the inside of the inner-side bulging portion 6. The cushion layer 14 extends from one end portion over the other end portion of the side wall 2 in the first direction. In other words, the cushion layer 14 extends from the edge portion 3A over the edge portion 3B in the first direction. In the present embodiment, the cushion layer 14 is disposed between the edge portion 3A and the edge portion 3B in the first direction. In the present embodiment, the cushion layer 14 is bonded to the heat insulating layer 13.

The cushion layer 14 is elastically deformable. As described later, when the battery cover 1 is fitted to the battery 100 (ref: FIG. 8A), the cushion layer 14 is deformed (recessed) in accordance with the shape of the outer surface of the battery 100. This allows the battery cover 1 to be smoothly fitted to the battery 100. Further, since the cushion layer 14 is deformed when the battery cover 1 is fitted to the battery 100, it is possible to suppress application of an excessive stress to the heat insulating layer 13, thereby protecting the heat insulating layer 13. Further, in a state where the battery cover 1 is fitted to the battery 100 (ref: FIG. 8B), the elasticity of the cushion layer 14 allows the first surface layer 11 to be reliably brought into contact with the side surface S3 of the battery 100. Thus, in a state where the battery cover 1 is fitted to the battery 100, it is possible to fill a space between the side surface S3 of the battery 100 and the heat insulating layer 13 with the cushion layer 14 and the first surface layer 11. As a result, it is possible to suppress an inflow of the air around the battery 100 into the space between the side surface S3 of the battery 100 and the heat insulating layer 13, and it is possible to suppress the conduction of the surrounding heat to the battery 100.

Examples of a material for the cushion layer 14 include the above-described heat insulating materials. The cushion layer 14 is preferably made of a foam-based heat insulating material, more preferably made of urethane foam.

The cushion layer 14 is softer than the heat insulating layer 13. The 50% compressive hardness of the cushion layer 14 is lower than that of the heat insulating layer 13. The 50% compressive hardness of the cushion layer 14 is, for example, below 10.0 kPa, preferably 8.0 kPa or less, more preferably 6.0 kPa or less, and for example, 1.0 kPa or more, preferably 1.5 kPa or more, more preferably 2.0 kPa or more. When the 50% compressive hardness of the cushion layer 14 is the above-described upper limit value or less, it is possible to easily deform the cushion layer 14 at the time of fitting the battery cover 1 to the battery 100. This allows the battery cover 1 to be smoothly fitted to the battery 100. When the 50% compressive hardness of the cushion layer 14 is the above-described lower limit value or more, it is possible to retain the shape of the cushion layer 14.

A compressive hardness retention rate after 120 seconds of the cushion layer 14 is, for example, 75% or more, preferably 80% or more, and for example, 95% or less.

When the compressive hardness retention rate after 120 seconds of the cushion layer 14 is the above-described lower limit value or more (i.e., the compressive hardness is less likely to decrease in a compressed state and is easily restored from the compressed state), it is possible to reliably restore the cushion layer 14 at the time of fitting the battery cover 1 to the battery 100, and it is possible to fill the space between the side surface S3 of the battery 100 and the heat insulating layer 13.

The thermal conductivity of the cushion layer 14 is 0.045 W/(m·K) or less, preferably 0.043 W/(m·K) or less, more preferably 0.040 W/(m·K) or less, further more preferably 0.035 W/(m·K) or less, further more preferably 0.033 W/(m·K) or less, further more preferably 0.030 W/(m·K) or less, and for example, 0.015 W/(m·K) or more.

In a state where the battery cover 1 is removed from the battery 100, a thickness of the cushion layer 14 is, for example, 1 mm or more, preferably 2 mm or more, and for example, 7 mm or less, preferably 5 mm or less. When the thickness of the cushion layer 14 is the above-described lower limit value or more, it is possible to ensure an amount of deformation of the cushion layer 14 at the time of fitting the battery cover 1 to the battery 100, and it is possible to improve the fitting properties of the battery cover 1 with respect to the battery 100. When the thickness of the cushion layer 14 is the above-described upper limit value or less, it is possible to suppress the excessive enlargement of the battery cover 1.

### 3. Producing Method of Battery Cover 1

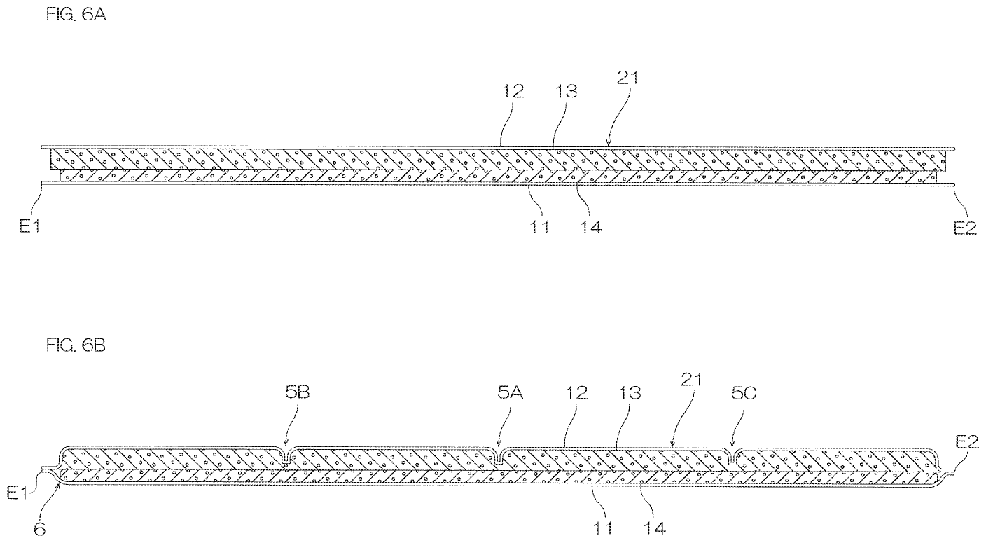

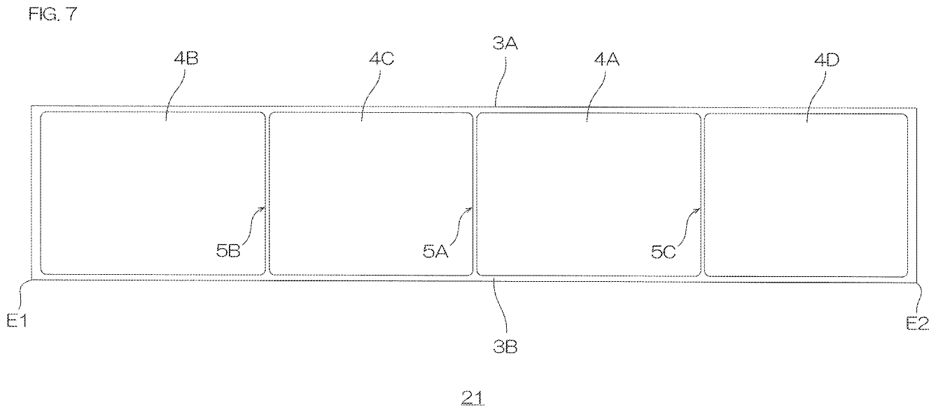

Next, a method for producing the battery cover 1 is described with reference to FIGS. 6A to 7.

In the present embodiment, a method for producing the battery cover 1 includes a laminating step (ref: FIG. 6A) and a molding step (ref: FIG. 6B).

As shown in FIG. 6A, in the laminating step, the first surface layer 11, the cushion layer 14, the heat insulating layer 13, and the second surface layer 12 are laminated in the thickness direction in the order of the first surface layer 11, the cushion layer 14, the heat insulating layer 13, and the second surface layer 12 to obtain a laminate 21.

When the first surface layer 11 and the second surface layer 12 are a nonwoven fabric in which a vinyl acetate-based resin, a polyester fiber (more specifically, a polyethylene terephthalate fiber), and a polypropylene fiber are laminated in the order of the vinyl acetate-based resin (resin layer), the polyester fiber (fiber layer), the polypropylene fiber (fiber layer), and the vinyl acetate-based resin (resin layer), the polypropylene fiber of the first surface layer 11 is disposed between the polyethylene terephthalate fiber of the first surface layer 11 and the cushion layer 14 in the thickness direction of the laminate 21. Further, the polypropylene fiber of the second surface layer 12 is disposed between the polyethylene terephthalate fiber of the second surface layer 12 and the heat insulating layer 13 in the thickness direction of the laminate 21.

The laminate 21 has a flat belt shape extending in a predetermined direction. The laminate 21 has one end portion E1 and the other end portion E2 in a direction in which the laminate 21 extends.

Also, if necessary, an adhesive tape or an adhesive is disposed between the first surface layer 11 and the second surface layer 12, between the second surface layer 12 and the heat insulating layer 13, and between the cushion layer 14 and the heat insulating layer 13 in the peripheral end portion (portion in which the edge portion 3A and the edge portion 3B are formed, and one end portion E1 and the other end portion E2) of the laminate 21. Examples of the adhesive include hot melt adhesives which can adhere by heating.

Next, as shown in FIGS. 6B and 7, in the molding step, by thermally pressing the laminate 21, the first surface layer 11 adheres to the second surface layer 12 in the peripheral end portion of the laminate 21 to form each recessed portion 5A to 5C at a predetermined position. Each recessed portion 5A to 5C is formed by compressing the heat insulating layer 13.

Thereafter, the laminate 21 is bent in each recessed portion 5A to 5C, and one end portion E1 is connected to the other end portion E2 of the laminate 21. Then, as shown in FIG. 3, the battery cover 1 is completed. The recessed portion 5D is formed by connecting one end portion E1 to the other end portion E2.

### 4. Fitting of Battery Cover 1 to Battery 100

Next, the fitting of the battery cover 1 to the battery 100 is described with reference to FIGS. 8A and 8B.

As shown in FIG. 8A, in the present embodiment, the battery cover 1 is fitted from above (one side in the first direction) with respect to the battery 100 placed on a predetermined flat surface.

At this time, in a conventional battery cover, when there is a protruding portion P (for example, the edge of the lid 102 of the battery 100 and the like) on the side surface S3 of the battery 100, the inner surface of the battery cover may be caught in the protruding portion P and may hinder the fitting of the battery cover to the battery 100.

In this regard, the battery cover 1 has the cushion layer 14 covered with the first surface layer 11 on the inner surface S11.

Therefore, when the battery cover 1 is fitted to the battery 100, at the time of the contact of the inner surface S11 of the battery cover 1 with the protruding portion P, the cushion layer 14 is deformed (recessed) in a portion (hereinafter, referred to as a contact portion) of the battery cover 1 in contact with the protruding portion P.

Then, as the battery cover 1 moves downwardly, the cushion layer 14 is deformed in order in the contact portion, and the first surface layer 11 slides with respect to the protruding portion P.

Thus, the battery cover 1 can smoothly ride over the protruding portion P. In the portion of the battery cover 1 that rides over the protruding portion P, the cushion layer 14 is restored by the elasticity of the cushion layer 14.

Then, as shown in FIG. 8B, when the entire battery cover 1 rides over the protruding portion P, the cushion layer 14 is restored in the entire battery cover 1, and the first surface layer 11 is pushed by the cushion layer 14 and brought into contact with the side surface S3 of the battery 100. In a state where the battery cover 1 is fitted to the battery 100, the cushion layer 14 and the first surface layer 11 fill the space between the side surface S3 of the battery 100 and the heat insulating layer 13.

Thus, the fitting of the battery cover 1 to the battery 100 is completed.

### 5. Function and Effect

(1) According to the battery cover 1, as shown in FIG. 8B, it has the first surface layer 11 in contact with the side surface S3 of the battery 100, and the cushion layer 14 disposed between the first surface layer 11 and the heat insulating layer 13.

As shown in FIG. 8A, when the battery cover 1 is fitted to the battery 100, the first surface layer 11 of the side wall 2 of the battery cover 1 slides with respect to the side surface S3 of the battery 100.

At this time, even when there is the protruding portion P on the side surface S3 of the battery 100, the cushion layer 14 disposed at the inside of the side wall 2 (between the first surface layer 11 and the heat insulating layer 13) is recessed (elastically deformed) in accordance with the protruding portion P, so that a catch of the first surface layer 11 by the protruding portion P can be suppressed.

Thus, even when there is the protruding portion P on the side surface S3 of the battery 100, the battery cover 1 can smoothly ride over the protruding portion P.

As a result, it is possible to smoothly fit the battery cover 1 to the battery 100.

Further, as shown in FIG. 8B, in a state where the fitting of the battery cover 1 to the battery 100 is completed, the elasticity of the cushion layer 14 allows the first surface layer 11 to be reliably brought into contact with the side surface S3 of the battery 100.

This allows the space between the side surface S3 of the battery 100 and the heat insulating layer 13 to be filled with the cushion layer 14 and the first surface layer 11.

As a result, it is possible to suppress an inflow of the air around the battery 100 into the space between the side surface S3 of the battery 100 and the heat insulating layer 13, and it is possible to suppress the conduction of the surrounding heat to the battery 100.

(2) According to the battery cover 1, the 50% compressive hardness of the cushion layer 14 is lower than that of the heat insulating layer 13.

Therefore, it is possible to easily deform the cushion layer 14, while the shape of the heat insulating layer 13 is retained.

(3) According to the battery cover 1, the 50% compressive hardness of the heat insulating layer 13 is 10.0 kPa or more, and the 50% compressive hardness of the cushion layer 14 is 1.0 kPa or more and below 10.0 kPa.

Therefore, it is possible to more easily deform the cushion layer 14, while the shape of the heat insulating layer 13 is further retained.

(4) According to the battery cover 1, the thermal conductivity of the heat insulating layer 13 is 0.045 W/(m·K) or less.

Therefore, it is possible to suppress the conduction of the surrounding heat to the battery 100 by the heat insulating layer 13.

(5) According to the battery cover 1, each of the heat insulating layer 13 and the cushion layer 14 is made of the foam-based heat insulating material or the fiber-based heat insulating material.

Therefore, it is possible to easily fit the battery cover 1 to the battery 100, and it is possible to improve the heat insulating properties.

(6) According to the battery cover 1, as shown in FIG. 4, the cushion layer 14 extends from one end portion over the other end portion of the side wall 2 in the first direction.

Therefore, as shown in FIG. 8B, in a state where the fitting of the battery cover 1 to the battery 100 is completed, it is possible to reliably bring the first surface layer 11 into contact with the side surface S3 of the battery 100 from one end portion over the other end portion of the side wall 2 of the battery cover 1 in the first direction.

(7) According to the battery cover 1, as shown in FIGS. 3 and 5, the outer surface S12 of the side wall 2 has the recessed portions 5A to 5C recessed in the thickness direction, and the outer-side bulging portions 4A to 4D bulging more than the recessed portions 5A to 5C in the thickness direction.

Therefore, it is possible to easily bend the side wall 2 in the recessed portions 5A to 5C, while the heat insulating properties are ensured in the outer-side bulging portions 4A to 4D.

(8) According to the battery cover 1, as shown in FIG. 5, in a state where the battery cover 1 is removed from the battery 100, a thickness of the heat insulating layer 13 in the recessed portions 5A to 5C is thinner than that of the heat insulating layer 13 in the outer-side bulging portions 4A to 4D.

Therefore, by molding the heat insulating layer 13, it is possible to form the recessed portions 5A to 5C, while the thickness of the cushion layer 14 is ensured.

(9) According to the battery cover 1, as shown in FIG. 5, in a state where the battery cover 1 is removed from the battery 100, the heat insulating layer 13 in the recessed portions 5A to 5C is compressed more than the heat insulating layer 13 in the outer-side bulging portions 4A to 4D in the thickness direction.

Therefore, by compressing the heat insulating layer 13, it is possible to easily form the recessed portions 5A to 5C.

(10) According to the battery cover 1, as shown in FIG. 1, the recessed portions 5A to 5C extend along the corners C1 to C3 of the battery 100.

Thus, it is possible to bend the side wall 2 in accordance with the corners C1 to C3 of the battery 100, and it is possible to fit the side wall 2 to the side surface S3 of the battery 100.

### 6. Modified Examples

Hereinafter, modified examples of the battery cover 1 are described. In the description of the modified examples, the same reference numerals are provided for members corresponding to each of those in the above-described embodiment, and their detailed description is omitted.

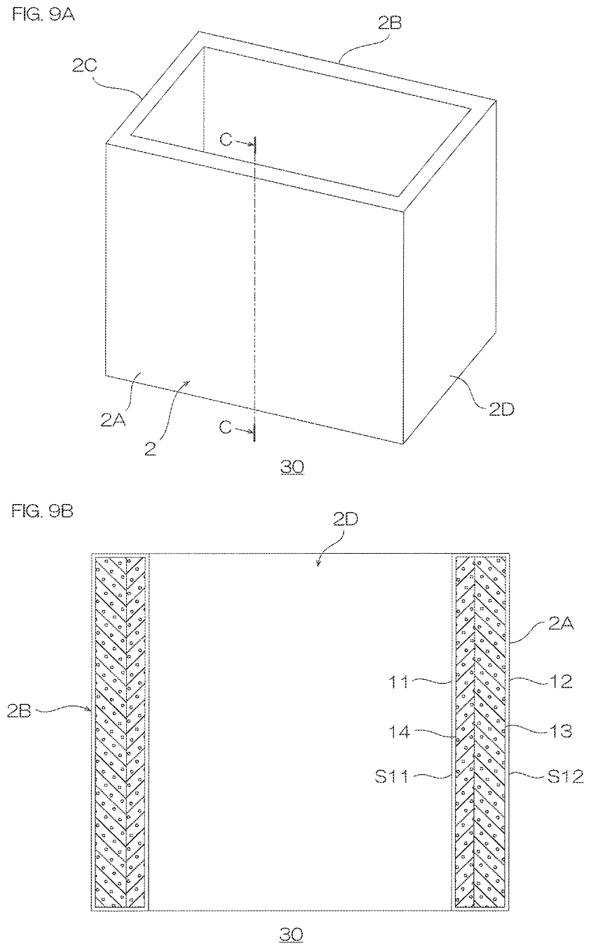

(1) As shown in FIGS. 9A and 9B, a battery cover 30 may not have the edge portions 3A and 3B, and the recessed portions 5A to 5D.

(2) The shape of the battery cover is not limited. The shape of the battery cover can be appropriately changed in accordance with the shape of the battery. For example, when the battery has a corner-free shape such as a columnar shape, the battery cover may have a cylindrical shape. Also, when the battery has a flat shape such as a flat plate shape, the battery cover may have the first side wall and the second side wall, and the battery may be sandwiched between the first side wall and the second side wall.

(3) The corners C1 to C4 of the battery 100 may be curved surfaces. In this case, the recessed portions 5A to 5D may be along the curved surface.

(4) The recessed portions 5A to 5C may be formed from the first surface layer 11 and the second surface layer 12. The heat insulating layer 13 and the cushion layer 14 may be eliminated in the recessed portions 5A to 5C.

(5) As shown in FIG. 10, the battery cover 1 may have the recessed portion 40 for avoiding interference between the member M disposed around the battery 100 and the side wall 2.

(6) As shown in FIG. 11, the cushion layer 14 may be present only in both end portions in an up-down direction of the side wall 2.

(7) The above-described modified examples can be appropriately used in combination.

### Examples

Next, the present invention is described based on Examples and Comparative Examples. The present invention is however not limited by the following Examples. The specific numerical values in property value and parameter used in the following description can be replaced with upper limit values (numerical values defined as “or less” or “below”) or lower limit values (numerical values defined as “or more”) of corresponding numerical values in property value and parameter described in the above-described “DESCRIPTION OF EMBODIMENTS”.

### 1. Preparation of Material

The following materials were prepared.

(1) TF1110R (urethane foam, manufactured by Wm. T. Burnett & Co.)

(2) UEI-3 (urethane foam, manufactured by INOAC CORPORATION)

(3) F2 (urethane foam, manufactured by INOAC CORPORATION)

### 2. Measurement of Properties of Material

(1) Thermal Conductivity

The thermal conductivity of each of the materials described above was measured at room temperature using a quick thermal conductivity meter (manufactured by KYOTO ELECTRONICS MANUFACTURING CO., LTD., trade name “QTM-500”).

(2) 50% Compressive Hardness

The 50% compressive hardness of each of the materials was measured using a testing machine (manufactured by Shimadzu Corporation, trade name “AG-XPlus”).

A test piece (width: 100 mm, length: 100 mm) was placed between parallel flat plates of the testing machine, and compressed only by 50% of the initial thickness at a compression rate of 5 mm/mm to be stopped, and then, the load P immediately after stopping the compression was measured. The 50% compressive hardness H1 was calculated based on the obtained load P by the following formula.

50% compressive hardness=load P÷area of test piece (100 mm×100 mm) Formula:

(3) Compressive Hardness Retention Rate after 120 Seconds

A compressive hardness retention rate of each of the materials after 120 seconds was measured using a testing machine (manufactured by Shimadzu Corporation, trade name “AG-XPlus”).

A test piece (width: 100 mm, length: 100 mm) was placed between parallel flat plates of the testing machine, and compressed only by 50% of the initial thickness at a compression rate of 5 mm/min to be stopped, and then, the load P immediately after stopping the compression was measured.

Then, the test piece as it is (in a state of being compressed only by 50% of the initial thickness) was retained for 120 seconds, and the load P2 after 120 seconds of the measurement of the load P was measured.

The 50% compressive hardness H1 was calculated based on the obtained load P by the above-described formula, and the 50% compressive hardness H2 after retention for 120 seconds was calculated based on the obtained load P2 by the above-described formula.

A percentage (H2+H1×100) of the 50% compressive hardness H2 with respect to the 50% compressive hardness H1 is referred to as the compressive hardness retention rate after 120 seconds.

### 3. Production of Battery Cover

### Example 1

The first surface layer, the cushion layer shown in Table 1, the heat insulating layer shown in Table 1, and the second surface layer were laminated in the thickness direction in the order of the first surface layer, the cushion layer, the heat insulating layer, and the second surface layer to obtain a laminate (laminating step, ref: FIG. 6A). The first surface layer and the second surface layer were made of a nonwoven fabric (nonwoven fabric in which a vinyl acetate-based resin, a polyethylene terephthalate fiber, and a polypropylene fiber (base fabric) were laminated in the order of the vinyl acetate-based resin (basis weight of 8 g/m²), the polyethylene terephthalate fiber (basis weight of 80 g/m²), the polypropylene fiber (basis weight of 17 g/m²), and the vinyl acetate-based resin (basis weight of 8 g/m²)). The polypropylene fiber of the first surface layer was disposed between the polyethylene terephthalate fiber of the first surface layer and the cushion layer in the thickness direction of the laminate. Further, the polypropylene fiber of the second surface layer was disposed between the polyethylene terephthalate fiber of the second surface layer and the heat insulating layer in the thickness direction of the laminate. An adhesive tape (trade name “TW-Y01”, manufactured by NITTO DENKO CORPORATION) was disposed between the second surface layer and the heat insulating layer, and between the cushion layer and the heat insulating layer.

Next, the laminate was thermally pressed (molding step, ref: FIG. 6B). The first surface layer and the second surface layer were thermally welded in the peripheral end portion of the laminate, and the edge portion was formed. Further, by compressing the heat insulating layer at a predetermined position, the recessed portion was formed. In addition, the second surface layer and the heat insulating layer were bonded by the adhesive tape, and the cushion layer and the heat insulating layer were bonded by the adhesive tape.

Thus, a sample of the battery cover was obtained.

### Examples 2 and 3 and Comparative Examples 1 to 3

A sample of the battery cover was obtained in the same manner as in Example 1, except that the heat insulating layer and the cushion layer were replaced with the heat insulating layer and the cushion layer shown in Table 1.

### 4. Property Evaluation of Battery Cover

(1) Heat Insulating Properties

<Shape of Test Piece>

A test piece A was cut out from each of the samples obtained in Examples and Comparative Examples described above.

As shown in FIG. 12, the test piece A was square. The test piece A had a bulging portion 4 and a recessed portion 5.

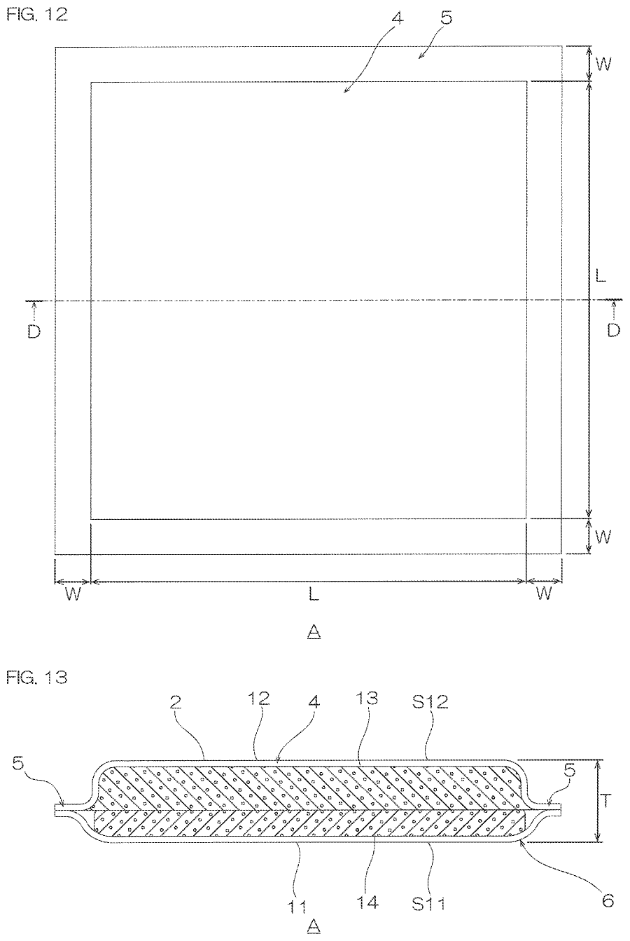

The bulging portion 4 was disposed at the center of the test piece A. The bulging portion 4 was square. A length L of an edge of the bulging portion 4 was 240 mm. As shown in FIG. 13, a thickness T of the bulging portion 4 was 10 mm.

As shown in FIG. 12, the recessed portion 5 was disposed around the bulging portion 4. A width W of the recessed portion 5 was 10 mm.

<Configuration of Evaluation Device>

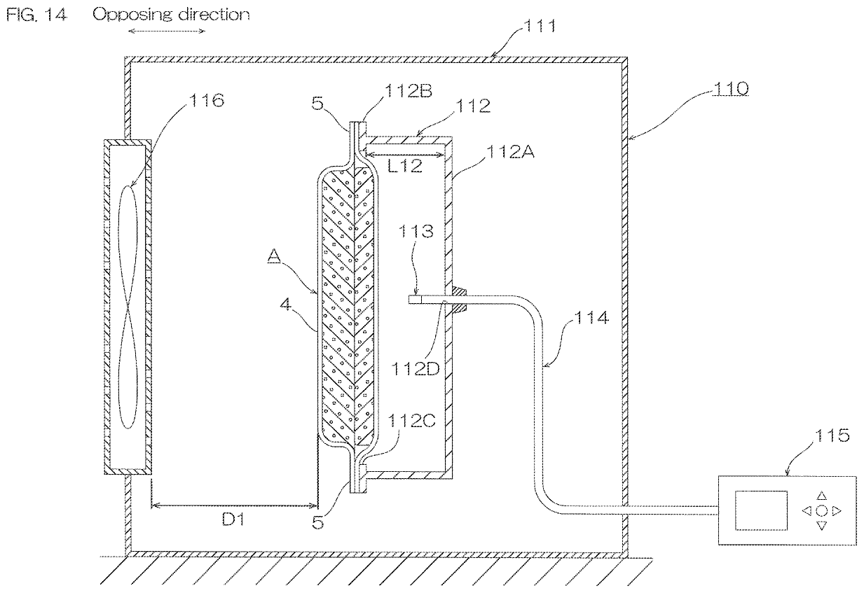

As shown in FIG. 14, an evaluation device 110 included a thermostatic chamber 111, a jig 112, a temperature sensor 113, a cable 114, and a data logger 115.

The thermostatic chamber 111 included a fan 116. As the thermostatic chamber 1l1, the “SH-242” manufactured by ESPEC Corp. was used.

The jig 112 was disposed at the inside of the thermostatic chamber 111. The jig 112 faced the fan 116 at spaced intervals thereto in an opposing direction. The opposing direction was a direction in which the jig 112 faced the fan 116. The jig 112 was made of a phenol resin foam having a thickness of 9 mm (trade name “NEOMA FOAM”, manufactured by ASAHI KASEI CONSTRUCTION MATERIALS CORPORATION). The jig 112 had a casing 112A and a flange 112B.

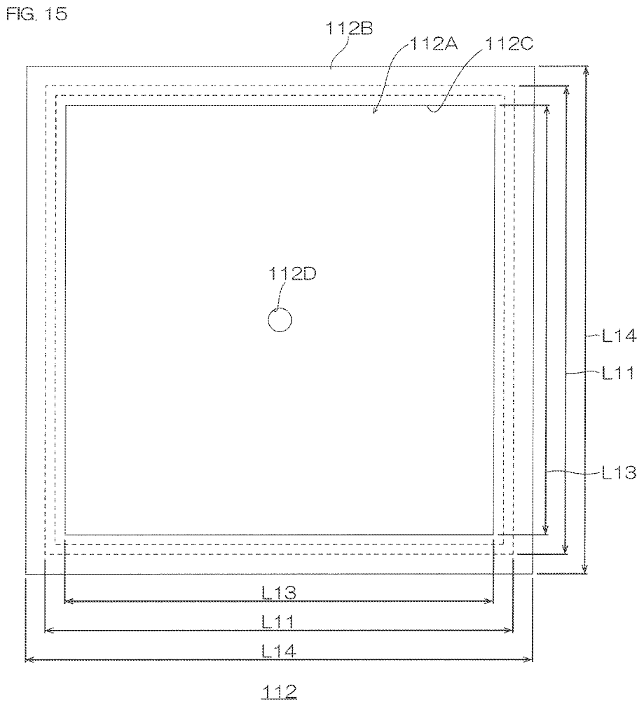

The casing 112A had one end portion and the other end portion in the opposing direction. One end portion was disposed between the fan 116 and the other end portion in the opposing direction. As shown in FIG. 15, the casing 112A was square when viewed from the opposing direction. An outer dimension L11 of the casing 112A was 240 mm. A depth (inner dimension in the opposing direction) L12 (ref: FIG. 14) of the casing 112A was 50 mm. The casing 112A had an opening 112C.

As shown in FIG. 14, the opening 112C was disposed in one end portion of the casing 112A in the opposing direction. As shown in FIG. 15, the opening 112C was square when viewed from the opposing direction. A dimension L13 of an edge of the opening 112C was 220 mm.

As shown in FIG. 14, the flange 112B extended from one end portion of the casing 112A in the opposing direction. The flange 112B extended in a direction perpendicular to the opposing direction. The flange 112B had a flat plate shape. As shown in FIG. 15, the outer shape of the jig 112 including the flange 112B was square when viewed from the opposing direction. An outer dimension L14 of the jig 112 including the flange 112B was 260 mm.

As shown in FIG. 14, the above-described test piece A was fixed to the jig 112. In a state where the test piece A was fixed to the jig 112, the bulging portion 4 of the test piece A closed the opening 112C of the jig 112. In a state where the test piece A was fixed to the jig 112, a distance D1 between the test piece A and the fan 116 was 150 mm.

The temperature sensor 113 measured the temperature of the inside of the casing 112A. As the temperature sensor 113, a K thermocouple defined in JIS C 1602: 2015 was used. The temperature sensor 113 was disposed at the inside of the casing 112A. The temperature sensor 113 was disposed at the center of the casing 112A in the opposing direction, and at the center of the casing 112A in a direction perpendicular to the opposing direction.

The cable 114 electrically connected the temperature sensor 113 to the data logger 115. One end portion of the cable 114 was electrically connected to the temperature sensor 113 through a through hole 112D provided in the wall of the casing 112A. The through hole 112D through which the cable 114 passed was filled with clay and the like. The other end portion of the cable 114 was electrically connected to the data logger 115.

The data logger 115 recorded the temperature measured by the temperature sensor 113.

<Evaluation Method of Heat Insulating Properties>

By using the evaluation device 110 described above, the heat insulating properties of the test piece A described above were measured. Specifically, by setting the set temperature of the thermostatic chamber III at 90° C. from a state where the temperature in the thermostatic chamber 111 was normal temperature (25° C.), constant value operation was carried out in the thermostatic chamber 111 to measure a temperature change in the casing 112A. The heat insulating properties of each of the test pieces A of Examples and Comparative Examples were evaluated from the obtained measurement results based on the following evaluation criteria. The results are shown in Table 1.

In Comparative Example 2, it is considered that the air permeability of the heat insulating layer is excessively high, and the performance of blocking the air flow caused by the rotation of the fan 116 is low, resulting in poor heat insulating properties.

<Evaluation Criteria>

◯: The temperature in the jig 112 10 minutes after starting the constant value operation of the thermostatic chamber 111 is below 65° C.

x: The temperature in the jig 112 10 minutes after starting the constant value operation of the thermostatic chamber Ill is 65° C. or more.

(2) Fitting Properties

<Shape of Test Piece>

A test piece B was cut out from each of the samples obtained in Examples and Comparative Examples described above.

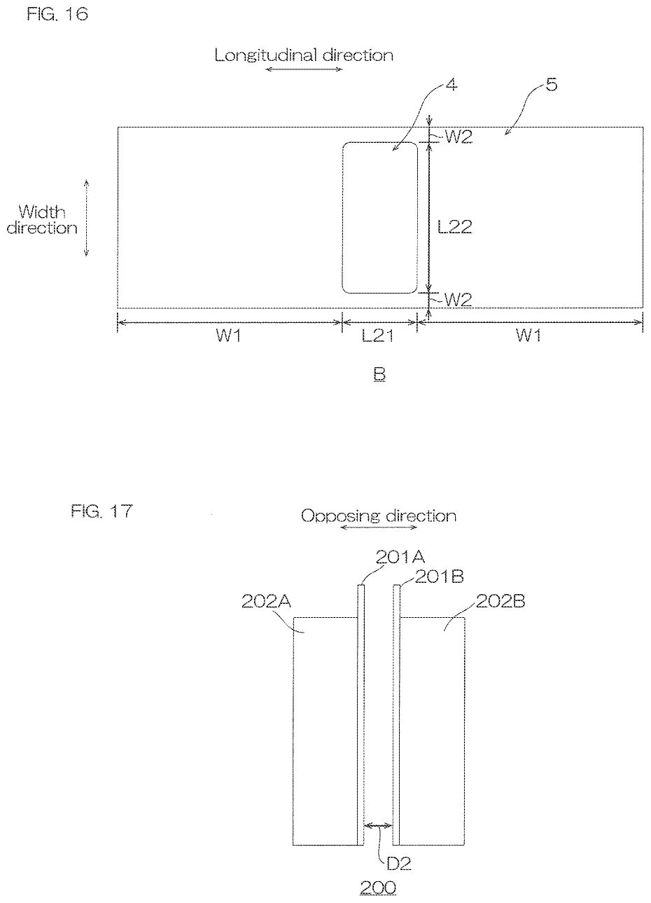

As shown in FIG. 16, the test piece B was rectangular. The test piece B had the bulging portion 4 and the recessed portion 5.

The bulging portion 4 was disposed at the center of the test piece B in a longitudinal direction of the test piece B. The bulging portion 4 extended in a width direction of the test piece B. The width direction of the test piece B was perpendicular to the longitudinal direction of the test piece B. A length L21 of the bulging portion 4 in the longitudinal direction of the test piece B was 50 mm. A length L22 of the bulging portion 4 in the width direction of the test piece B was 100 mm. A thickness of the bulging portion 4 was 10 mm, which was the same as the thickness T of the test piece A described above.

The recessed portion 5 was disposed around the bulging portion 4. A width W1 of the recessed portion 5 in the longitudinal direction of the test piece B was 150 mm. A width W2 of the recessed portion 5 in the width direction of the test piece B was 10 mm.

<Configuration of Evaluation Device>

As shown in FIG. 17, an evaluation device 200 included two plates 201A and 201B, and two columns 202A and 202B.

The plate 201B faced the plate 201A at spaced intervals thereto in the opposing direction. The opposing direction was a direction in which the plate 201A faced the plate 201B. Each of the plates 201A and 201B extended in a direction perpendicular to the opposing direction. A distance D2 between the plate 201A and the plate 201B in the opposing direction was 7 mm, which was shorter than the thickness of the bulging portion 4 of the test piece B (ref FIG. 16). Each of the plates 201A and 201B was made of polypropylene.

The column 202A supported the plate 201A. The column 202A was disposed on an opposite side of the plate 201B with respect to the plate 201A in the opposing direction.

The column 202B supported the plate 201B. The column 202B was disposed on an opposite side of the plate 201A with respect to the plate 201B in the opposing direction.

<Evaluation Method of Fitting Properties>

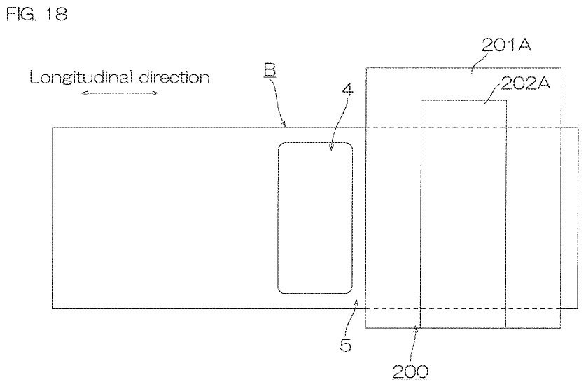

By using the evaluation device 200 described above, the fitting properties of the test piece B described above were evaluated. Specifically, as shown in FIG. 18, one end portion of the test piece B in the longitudinal direction was disposed between the plate 201A and the plate 201B. At this time, one surface in the thickness direction of the test piece B faced the plate 201A, and the other surface in the thickness direction of the test piece B faced the plate 201B.

Then, the test piece B was pulled in the longitudinal direction, and the fitting properties of each of the test pieces B of Examples and Comparative Examples were evaluated based on the following evaluation criteria. The results are shown in Table 1.

<Evaluation Criteria>

◯: The bulging portion 4 was capable of passing between the plate 201A and the plate 201B.

x: The bulging portion 4 was incapable of passing between the plate 201A and the plate 201B.

TABLE 1

| | | Ex. 1 | Ex. 2 | Ex. 3 | Comp. Ex. 1 | Comp. Ex 2 | Comp. Ex. 3 |
|---|---|---|---|---|---|---|---|
| Heating | Material | TF1100R | TF1100R | F2 | TF1100R | UEI-3 | TF1100R |
| Insulating Layer | Thermal Conductivity | 0.0400 | 0.0400 | 0.0403 | 0.0400 | 0.0401 | 0.0400 |
| | Compressive Hardness | 13.3 kPa | 13.3 kPa | 5.8 kPa | 13.3 kPa | 4.7 kPa | 13.3 kPa |
| | Retention Rate | 67% | 67% | 83% | 67% | 79% | 67% |
| Cushion Layer | Material | UEI-3 | F2 | UEI-3 | Absence | Absence | TF1100R |
| | Thermal Conductivity | 0.0401 | 0.0403 | 0.0401 | — | — | 0.0400 |
| | Compressive Hardness | 4.7 kPa | 5.8 kPa | 4.7 kPa | — | — | 13.3 kPa |
| | Retention Rate | 79% | 83% | 79% | — | — | 67% |

| | | | | | | |
|---|---|---|---|---|---|---|
| Heat Insulating Properties | ○ | ○ | ○ | ○ | x | ○ |
| Fitting Properties | ○ | ○ | ○ | x | ○ | x |

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

### INDUSTRIAL APPLICATION

The battery cover of the present invention is used to suppress conduction of the surrounding heat to a battery.

### DESCRIPTION OF REFERENCE NUMBER

1 Battery cover
2 Side wall
4A to 4D Outer-side bulging portion
5A to 5D Recessed portion
11 First surface layer
12 Second surface layer
13 Heat insulating layer
14 Cushion layer
30 Battery cover
40 Recessed portion
100 Battery
C1 to C4 Corner
S1 First surface
S2 Second surface
S3 Side surface
S11 Inner surface
S12 Outer surface

1. A battery cover comprising:
a side wall covering a side surface of a battery, wherein
the side wall includes
a first surface layer in contact with the side surface of the battery,
a second surface layer disposed on an opposite side of the side surface of the battery with respect to the first surface layer in a thickness direction of the side wall,
a heat insulating layer disposed between the first surface layer and the second surface layer in the thickness direction, and
a cushion layer disposed between the first surface layer and the heat insulating layer in the thickness direction.

2. The battery cover according to claim 1, wherein
the 50% compressive hardness of the cushion layer is lower than the 50% compressive hardness of the heat insulating layer.

3. The battery cover according to claim 2, wherein
the 50% compressive hardness of the heat insulating layer is 10.0 kPa or more and
the 50% compressive hardness of the cushion layer is 1.0 kPa or more and below 10.0 kPa.

4. The battery cover according to claim 1, wherein
the thermal conductivity of the heat insulating layer is 0.045 W/(m·K) or less.

5. The battery cover according to claim 1, wherein
each of the heat insulating layer and the cushion layer is made of a fiber-based heat insulating material or a foam-based heat insulating material.

6. The battery cover according to claim 1, wherein
the battery has a first surface on which a terminal is disposed, a second surface away from the first surface in a first direction, and the side surface disposed between the first surface and the second surface in the first direction and extending in the first direction, and
the cushion layer extends from one end portion over the other end portion of the side wall in the first direction.

7. The battery cover according to claim 1, wherein
the side wall has an inner surface in contact with the side surface of the battery in the thickness direction and an outer surface disposed on an opposite side of the side surface of the battery with respect to the inner surface in the thickness direction, and
the outer surface has
a recessed portion recessed in the thickness direction and
a bulging portion bulging more than the recessed portion in the thickness direction.

8. The battery cover according to claim 7, wherein
in a state where the battery cover is removed from the battery, a thickness of the heat insulating layer in the recessed portion is thinner than the thickness of the heat insulating layer in the bulging portion.

9. The battery cover according to claim 7, wherein
in a state where the battery cover is removed from the battery, the heat insulating layer in the recessed portion is compressed more than the heat insulating layer in the bulging portion in the thickness direction.

10. The battery cover according to claim 7, wherein
the recessed portion extends along a corner of the battery.
